(19) United States
(12) Patent Application Publication
(10) Pub. No.: US 2017/0228836 A1
(43) Pub. Date: Aug. 10, 2017

(54) SYSTEM AND METHOD FOR PROVIDING TRANSPORTATION SERVICES

(71) Applicant: Lucky MPHELA, Johannesburg (ZA)

(72) Inventor: Lucky MPHELA, Johannesburg (ZA)

(21) Appl. No.: 15/211,712

(22) Filed: Jul. 15, 2016

(30) Foreign Application Priority Data
May 27, 2015 (ZA) 2015/03821
May 30, 2016 (ZA) 2016/03688

(51) Int. Cl. G06Q 50/14; G06Q 10/02; G06F 3/14

(52) U.S. Cl. CPC G06Q 50/14; G06F 3/1423; G06Q 10/02; G06Q 50/30

(57) ABSTRACT

A system and method for providing transportation services to a traveler arriving at a transportation hub are provided, the system comprising a plurality of uprights, each upright having a display, with the plurality of uprights arranged in discrete rows. The length of the uprights are selected to prevent obstruction of any one of the displays, and each display is connected to a computer which causes at least a first name of a first traveler to be displayed on the corresponding display. In use, the first traveler identifies a display displaying his/her name and positions himself/herself at the display bearing his/her name to be met by a representative of a transportation service provider.

### CROSS REFERENCE TO RELATED APPLICATIONS

This application claims priority under 35 U.S.C. §119 to South African Application No. 2016/03688, filed on May 30, 2016, as well as South African Provisional Application No. 2015/03821, filed on May 27, 2015, the contents of each of which are incorporated by reference herein.

### FIELD OF INVENTION

This invention relates to a system and method for providing transportation services.

### BACKGROUND

When travelling passengers, such as those utilizing airline services, arrive at their destination, typically a transportation hub such as an airport, systems and methods for providing transport services onward to places of accommodation, business or leisure are rudimentary. Typically, a person providing such transport services, such as a taxi driver or other transport provider, stands in a designated area holding up a paper name card and waits for the requisite passenger to arrive. Such systems and methods are extremely hit and miss and require the transport provider to hold up the sign in an obvious manner to hopefully be recognized by the traveler in a crowded arrivals hall of the transportation hub.

The above mentioned system and method for providing transport services are known to travelers utilizing different transport means such as airplanes, trains, busses and boats. The arrival termini for all the above transport means are typically overcrowded hindering the traveler from meeting the transport provider and/or a representative of said transport provider. Furthermore, the traveler does not always know what the transport provider representative will look like, or where he/she might be waiting (or vice versa). Not knowing the precise time that the traveler will show up is detrimental to the representative of the transportation service provider as he/she must hold-up the name card until such time that the traveler recognizes his/her name. This time frame may range from 15 minutes to 2 hours and causes a great deal of unwanted confusion, delay and exhaustion.

This known system and method for providing transport services also causes unwanted delays for the traveler. Similarly, this known system and method may well cause the transport provider to have to re-arrange his/her schedule if a traveler is not timeously met and attended to, which may in turn cause delays for future travelers on the transport provider's schedule.

The known system and method is inefficient and leads to transport providers, such as taxi service, operating at below optimum levels negatively impacting on the economic viability of such transport provider businesses. Similarly, the known system results in great time wastes for the traveler. Furthermore, the known system and method rely heavily on the use of paper thus negatively impacting on the environment.

The present invention seeks to at least ameliorate one of the above mentioned problems.

### SUMMARY

In broad terms, and in accordance with a first aspect of this invention there is provided a system for providing transportation services to a traveler arriving at a transportation hub, the system comprising a plurality of uprights, each upright having a display means connected thereto, the plurality of uprights arranged in discrete rows, the length of the uprights being selected so as to prevent obstruction of any one of the display means, each display means being connected to a computer which causes at least a first name of a first traveler to be displayed on one of the plurality of display means, such that in use, the first traveler identifies a display means displaying his/her name and positions himself/herself at the display means bearing his/her name to be met by a representative of a transportation service provider.

It is to be understood that typically the computer causes second and subsequent names of second and subsequent travelers to be displayed on at least one of the plurality of display means. Typically, each of the first, second and subsequent names are independently displayed on separate display means forming part of the plurality of display means. In a certain embodiment of the invention it is envisioned that a single display means may display more than one name.

Typically, the uprights in each different row are of a particular length, such that in use, a front row includes uprights of a lowest length and a back row includes uprights of a greatest length allowing the display means in each of the rows to be un-obscured for visual recognition by the traveler. It is to be understood that the uprights comprising the discrete rows may be of various lengths and arranged to prevent obstruction of any one of the display means in use. The uprights may comprise hydraulic adjustment means in use to adjust the length of the upright.

The rows may form straight lines, or the rows may be curved. It is to be understood that alone, or in combination, each row, or the plurality of rows, may define different shapes and/or patterns.

The computer may include computer enabled software containing information about at least the first traveler. Preferably, the computer enabled software contains information about the first, second and subsequent travelers. The information may include at least one of, but not limited to, the following group: name, surname, identification number, photo identification, scheduled arrival time, mode of arrival, flight number, train number, bus number, boat number, name of transportation service provider and name of the transport service provider representative allocated to meet the traveler. It is to be understood that any of the aforementioned information may be caused to be displayed on the display means, alone or in combination. In an embodiment of the invention at least the traveler name and photo are caused to be displayed on the display means.

In a particularly embodiment of the invention, each of the plurality of uprights includes two display means, one to display the traveler's name in use and another to display the traveler's photograph in use.

Typically, the computer enabled software may be linked to a first database of a first transport service provider, preferably the computer enabled software may be linked to several different databases of several different transport service providers. In an example embodiment of the invention where the transport service provider may be a taxi service, the computer enable software is linked to several different databases of several different taxi service operators such that in use, the first, second or subsequent traveler who has booked a taxi service with any one of the several different taxi service operators arrives at the plurality of uprights, identifies his/her name on a display means and is met by a representative of the taxi service.

The computer enabled software may be linked to a second database of the transportation hub in use to track arrival times and cause the same to be displayed on at least one of the display means. Alternatively, arrival times displayed at the transportation hub are viewed and caused to be displayed on at least one of the display means.

The computer enabled software may be linked to the first database of the first transportation service provider, preferably the computer enabled software may be linked to several different databases of several different transport service providers, and the computer enabled software may be linked to the second database of the transportation hub, such that in use, the computer can cause the names of first, second and subsequent travelers to be displayed in order of arrival times. Once the first traveler has been met by the first representative the computer causes the display means to display a second traveler. It is to be understood that after the first traveler has been met by the first representative a signal is sent to the computer to display the name of a second traveler. Said signal may be manually input into the computer and/or may be sent to the computer via an email or SMS or other electronic communication means.

Each of the plurality of uprights may have adjacent thereto a seating arrangement, in use, allowing the representative of the transportation service provider to wait for the arrival of the traveler.

In an alternative embodiment of the invention, each of the plurality of uprights may have a seating arrangement integral thereto, in use, allowing the representative of the transportation service provider to wait for the arrival of the traveler.

The system may further comprise a base comprising a plurality of receiving means, each receiving means to operatively receive an upright. The base may be integral or separate from a floor where upon the system is located within the transportation hub.

The computer may be linked to the plurality of display means via a wireless connection. In a certain embodiment of the invention the computer is a laptop computer and is placed on top of a mobile computer stand and linked to the plurality of display means via conventional cabling technologies. A combination of wireless and conventional cabling technologies is also envisaged.

It is envisioned that the first, second and subsequent traveler may receive an electronic communication from the computer upon arrival at the transportation hub informing said traveler where the system is located in the transportation hub and/or at which display means he/she should report to and/or the name of the representative of the transportation service provider. The electronic communication may be, but not limited to, at least one of the following forms: SMS and email, which may be received by the traveler's own computer and/or smart phone and/or tablet.

The Applicant believes the invention may at least alleviate congestion at arrival halls for various transportation means, such as for example airports. Further, the Applicant believes the invention may decrease the time taken for a traveler to meet with his/her transportation service provider, such as for example a taxi driver from a taxi service booked by the traveler. The Applicant believes that the invention may ease the burden of holding up a conventional paper name card therein reducing fatigue. Finally, the invention reduces use of paper.

In broad terms, and in accordance with a second aspect of this invention there is provided a method for providing transportation services to a traveler arriving at a transportation hub, the method comprising the following steps:
a first traveler making a reservation for a first transportation service provider; the first transportation service provider sending information relating to the first traveler to a computer;
the computer causing the name of the first traveler to be displayed on a display means that is mounted to an upright and located at the transportation hub;
the first traveler reporting to the display means bearing his/her name;
a first representative of the transportation service provider meeting the first traveler;
communicating with the computer that the first traveler has been met by the first representative;
the computer causing the name of a second traveler to be displayed on the display means.

The display means and upright may form part of the system described in the first aspect of this invention.

In an embodiment of the invention, the step of communicating with the computer that the first traveler has been met by the first representative may be actioned by pressing a button on the display means, and the step of the computer causing the name of a second traveler to be displayed on the display means may be actioned by pressing the button on the display means for a second time.

The computer may include computer enabled software containing information about at least the first traveler. Preferably, the computer enabled software contains information about the first, second and subsequent travelers. The information may include at least one of, but not limited to, the following group: name, surname, identification number, scheduled arrival time, mode of arrival, flight number, train number, bus number, boat number, name of transportation service provider and name of the transport service provider representative allocated to meet the traveler.

Typically, the computer causes the name of the first, second and subsequent traveler to be displayed on the display means at least from a time that corresponds to the scheduled arrival time for said first, second and subsequent traveler.

Typically, the computer enabled software may be linked to a first database of a first transport service provider, preferably the computer enabled software may be linked to several different databases of several different transport service providers. In an example embodiment of the invention where the transport service provider may be a taxi service, the computer enabled software is linked to several different databases of several different taxi service operators such that in use, the first, second or subsequent traveler who have booked a taxi service with any one of the several different taxi service operators arrives at the plurality of uprights, identifies his/her name on a display means and is met by a representative of the taxi service.

The computer enabled software may be linked to a second database of the transportation hub in use to track arrival times and cause the same to be displayed on at least one of the display means.

The computer enabled software may be linked to the first database of the first transportation service provider, preferably the computer enabled software may be linked to several different databases of several different transport service providers, and the computer enabled software may be linked to the second database of the transportation hub, such that in use, the computer can cause the names of first, second and subsequent travelers to be displayed in order of arrival times. Once the first traveler has been met by the first representative the computer causes the display means to display a second traveler. It is to be understood that after the first traveler has been met by the first representative a signal is sent to the computer to display the name of a second traveler. Said signal may be manually input into the computer and/or may be sent to the computer via an email or SMS or other electronic communication means. Alternatively, it is to be understood that after the first traveler has been met by the first representative a button located on the display means may be actioned in so doing communicating with the computer that the first traveler has been met by the first representative. Similarly, the step of the computer causing the name of a second traveler to be displayed on the display means may be actioned by pressing the button for a second time.

The computer may be linked to the plurality of display means via a wire and/or wireless connection.

It is envisioned that the method may include a further step whereby the first, second and subsequent traveler may receive an electronic communication from the computer upon arrival at the transportation hub informing said traveler where the system is located in the transportation hub and/or at which display means he/she should report to and/or the name of the representative of the transportation service provider. The electronic communication may be, but not limited to, at least one of the following forms: SMS and email, which may be received by the traveler's own computer and/or smart phone and/or tablet.

The Applicant believes the invention may at least alleviate congestion at arrival halls for various transportation means, such as for example airports. Further, the Applicant believes the invention may decrease the time taken for a traveler to meet with his/her transportation service provider, such as for example a taxi driver from a taxi service booked by the traveler.

There is further provided for a system and/or a method according to this invention, substantially described, illustrated and/or exemplified with reference to any one of the accompanying diagrammatic figures.

### BRIEF DESCRIPTION OF THE DRAWINGS

Embodiments of the invention will be described below by way of example only and with reference to the accompanying drawings in which:

FIG. 1 shows an example embodiment of a system for providing transportation services to a traveler arriving at a transportation hub in accordance with a first aspect of the invention;

FIG. 2 shows a side view of the system according to the first aspect of the invention;

FIG. 3 shows a second example embodiment of a system for providing transportation services to a traveler arriving at a transportation hub in accordance with a first aspect of the invention, wherein each upright includes two display means, one to display the traveler's name in use and another to display the traveler's photograph in use; and

FIG. 4 shows an example embodiment of a method for providing transportation services to a traveler arriving at a transportation hub in accordance with a second aspect of this invention.

### DETAILED DESCRIPTION OF THE DRAWINGS

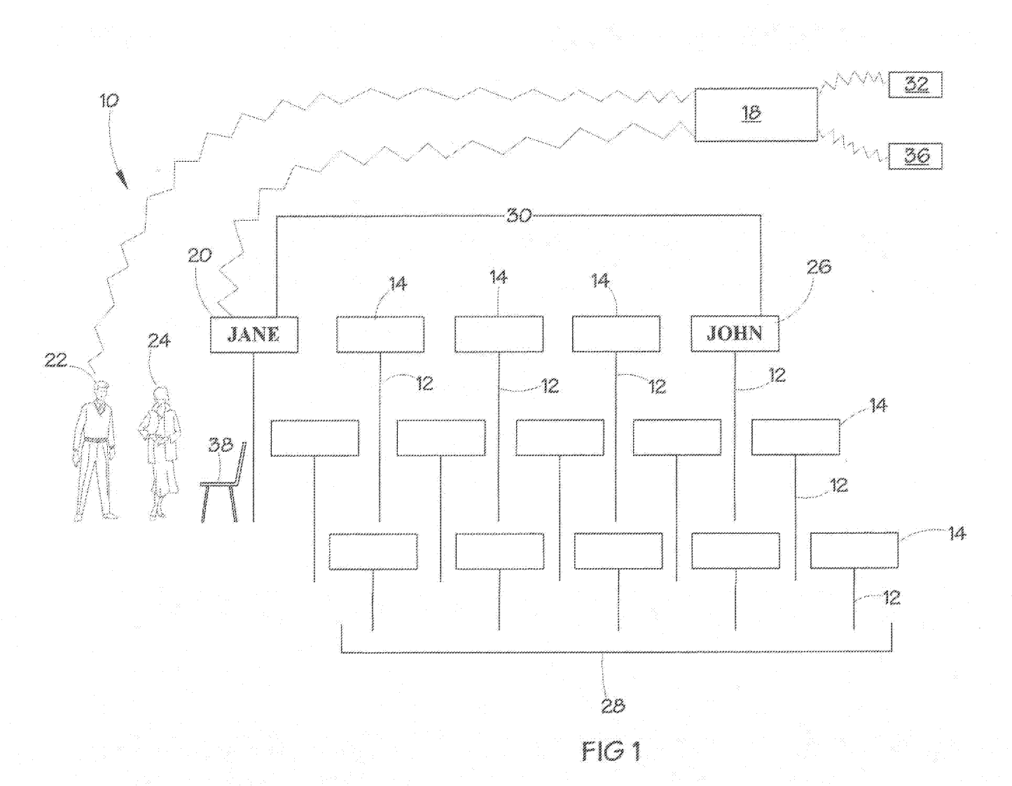

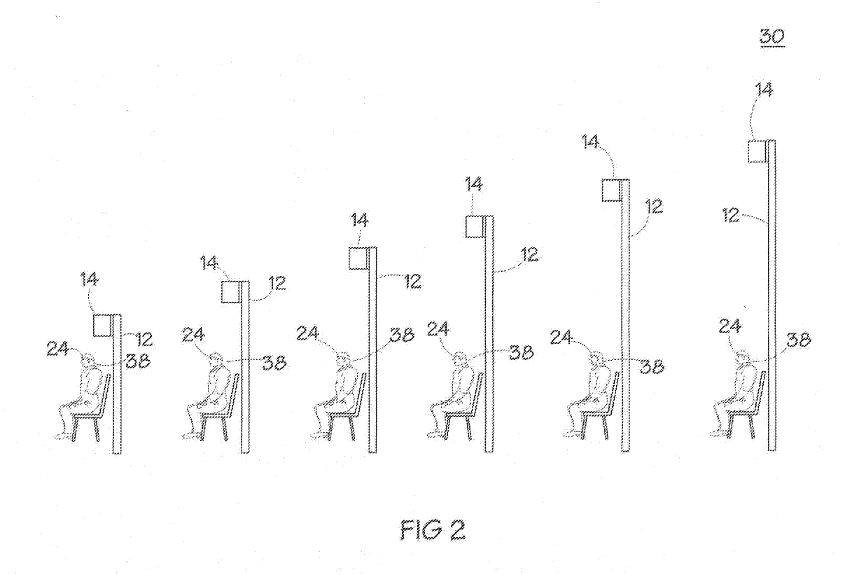

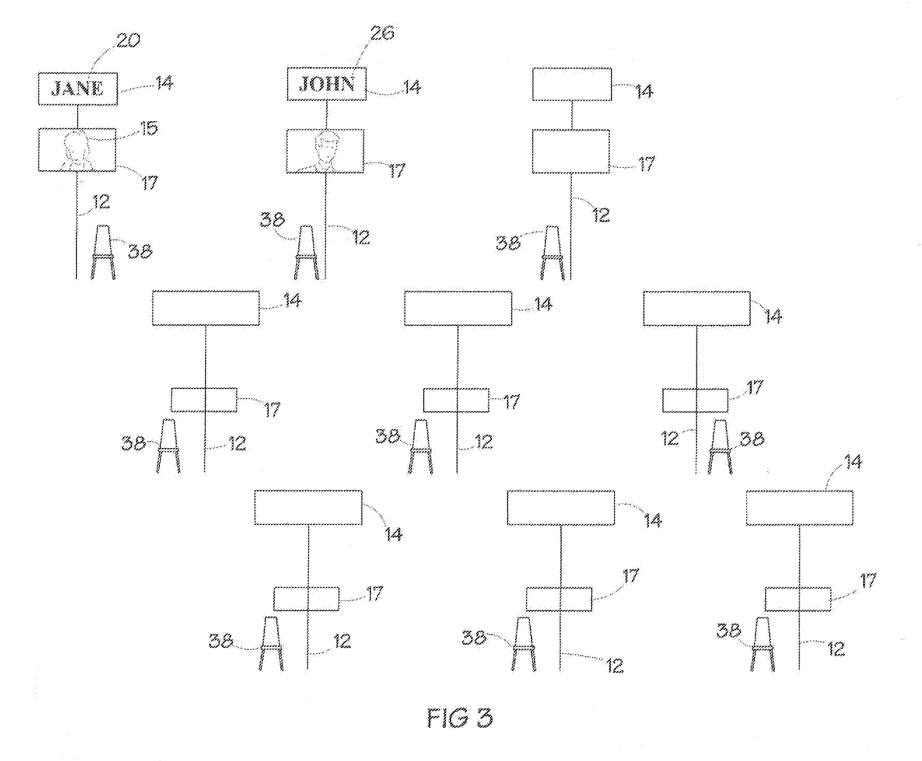

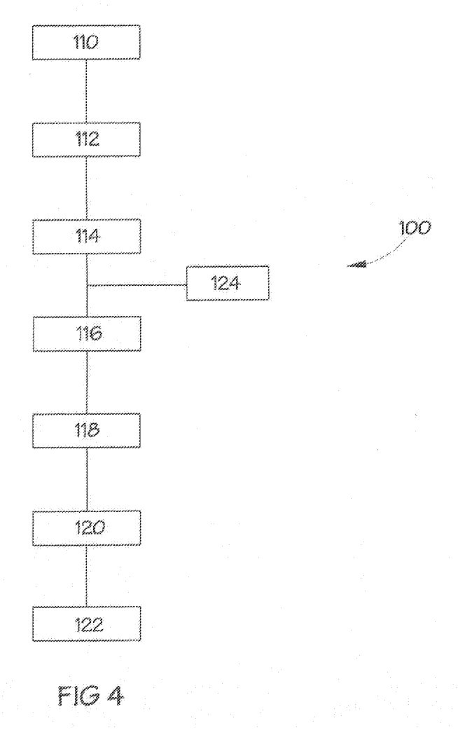

Referring to the accompanying diagrammatic drawings FIGS. 1 and 2 shows a first example embodiment of a system 10 for providing transportation services to a traveler arriving at a transportation hub in accordance with a first aspect of the invention, FIG. 3 shows a second example embodiment of the first aspect of the invention, and FIG. 4 shows an example embodiment of a method 100 for providing transportation services to a traveler arriving at a transportation hub in accordance with a second aspect of this invention.

In accordance with a first aspect of this invention there is provided a system 10 for providing transportation services to a traveler arriving at a transportation hub as shown in FIGS. 1 and 2. The system 10 comprises a plurality of uprights 12, each upright having a display means 14 connected thereto. The plurality of uprights 12 are arranged into discrete rows. The length of the uprights 12 being selected so as to prevent obstruction of any one of the display means 14. Each display means 14 being connected to a computer 18 which causes at least a first name 20 of a first traveler 22 to be displayed on one of the plurality of display means 14, such that in use, the first traveler 22 identifies a display means 14 displaying his/her name and positions himself/herself at the display means 14 bearing his/her name to be met by a representative 24 of a transportation service provider.

It is to be understood that typically the computer 18 causes second 26 and subsequent names of second and subsequent travelers to be displayed on at least one of the plurality of display means. The first name 20 as shown in FIG. 1 is “Jane” and the second name 26 as shown in FIG. 1 is “John”. Typically, each of the first, second and subsequent names are independently displayed on separate display means. In a certain embodiment of the invention it is envisioned that a single display means 14 may display more than one name.

The Applicant envisages that the display means 14 may also display a photograph 15 of the traveler, as shown in FIG. 3 a second example embodiment of the first aspect of the invention. In this embodiment of the invention, each upright includes two display means, one display means 14 to display traveler name, shown in FIG. 3 as the first name 20, and another to display means 17 the traveler's photograph 15, in this case a photograph of “Jane” 15.1 and a photograph of “John” 15.2. A third display means may be affixed to the upright if desired to display information about for example the transportation service provider. Such third display means may be electronic and/or magnetic and/or cardboard.

Typically, the uprights 12 in each different row are of a particular length, such that in use, a front row 28 includes uprights of a lowest length and a back row 30 includes uprights 12 of a greatest length allowing the display means 14 in each of the rows to be un-obscured for visual recognition by the traveler when viewed by a traveler proximal the front row 28 looking toward the back row 30 which is distal the traveler. The above described embodiment is shown in FIGS. 1 and 2. It is to be understood that the uprights comprising the discrete rows may be of various lengths and arranged to prevent obstruction of any one of the display means in use. For example, the rows may be curved and/or each row may have an upright of greater length in the middle and progressively shorter uprights spaced away from the middle. It is clearly shown in FIG. 2, a side view of the system 10, that should a traveler be positioned proximal the front row 28 his/her view of the display means 14 in the front row 28 and all the rows including the back row 30 will be un-obscured.

The rows may form straight lines, or the rows may be curved. It is to be understood that alone, or in combination, each row, or the plurality of rows, may define different shapes and/or patterns.

The computer 18 typically includes computer enabled software (not shown) containing information about at least the first traveler 22. Preferably, the computer enabled software contains information about the first, second and subsequent travelers. The information may include at least one of, but not limited to, the following group: name, surname, identification number, photo identification, scheduled arrival time, mode of arrival, flight number, train12 number, bus number, boat number, name of transportation service provider and name of the transport service provider representative allocated to meet the traveler.

Typically, the computer enabled software may be linked to a first database 32 of a first transport service provider, preferably the computer enabled software may be linked to several different databases of several different transport service providers. In an example embodiment of the invention where the transport services provider may be a taxi service, the computer enabled software is linked to several different databases of several different taxi service operators (i.e. Avis, Europe Car, Budget Car, etc) such that in use, the first, second or subsequent traveler who has booked a taxi service with any one of the several different taxi service providers arrives at the plurality of uprights, identifies his/her name (and/or his/her photograph) on a display means and is met by a representative of the taxi service.

The computer enabled software may be linked to a second database 36 of the transportation hub in use to track arrival times and cause the same to be displayed on at least one of the display means.

The computer enabled software is linked to the first database 32 of the first transportation service provider, preferably the computer enabled software may be linked to several different databases of several different transport service providers, and the computer enabled software is linked to the second database 36 of the transportation hub, such that in use, the computer can cause the names of first, second and subsequent travelers to be displayed in order of arrival times. Once the first traveler 22 has been met by the first representative 24 the computer 18 causes the display means to display a second traveler name. It is to be understood that after the first traveler 22 has been met by the first representative 24 a signal is sent to the computer to display the name of a second traveler. Said signal may be manually input into the computer and/or may be sent to the computer via an email or SMS or other electronic communication means. A person having skill in the art would readily be able to program alternative methods of sending signals to the computer 18 in order to remove the first traveler name and in order to display the second traveler name. It is envisaged that the traveler may interact with the computer directly.

Each of the plurality of uprights 12 typically has adjacent thereto a seating arrangement 38, in use, allowing the representative of the transportation service provider to wait for the arrival of the traveler.

In an alternative embodiment of the invention, each of the plurality of uprights may have a seating arrangement integral thereto, in use, allowing the representative of the transportation service provider to wait for the arrival of the traveler.

The system may further comprise a base (not shown) comprising a plurality of receiving means, each receiving means to operatively receive an upright 12. The base may be integral or separate from a floor where upon the system is located.

The computer 18 may be linked to the plurality of display means 14 via a wireless connection.

It is envisioned that the first, second and subsequent traveler may receive an electronic communication from the computer upon arrival at the transportation hub informing said traveler where the system is located in the transportation hub and/or at which display means he/she should report to and/or the name of the representative of the transportation service provider. The electronic communication may be, but not limited to, at least one of the following forms: SMS and email, received by the traveler's own computer and/or smart phone and/or tablet.

The computer 18 may be connected to an uninterrupted power supply to ensure that the system remains active during power outages.

The Applicant believes the invention may at least alleviate congestion at arrival halls for various transportation means, such as for example airports. Further, the Applicant believes the invention may decrease the time taken for a traveler to meet with his/her transportation service provider, such as for example a taxi driver from a taxi service booked by the traveler.

In accordance with a second aspect of this invention there is provided a method 100 for providing transportation services to a traveler arriving at a transportation hub as shown in FIG. 4.

The method 100 comprises the following steps:
a first traveler booking for use of a first transportation service provider 110;
the first transportation service provider sending information relating to the first traveler to a computer 112;
the computer causing the name of the first traveler to be displayed on a display means that is mounted to an upright and located at the transportation hub 114;
the first traveler reporting to the display means bearing his/her name 116;
a first representative of the transportation service provider meeting the first traveler 118;
communicating with the computer that the first traveler has been met by the first representative 120;
the computer causing the name of a second traveler to be displayed on the display means 122.

The display means and upright generally forms part of the system described in the first aspect of this invention.

The computer typically includes computer enabled software containing information about at least the first traveler. Preferably, the computer enabled software contains information about the first, second and subsequent travelers. The information may include at least one of, but not limited to, the following group: name, surname, identification number, scheduled arrival time, mode of arrival, flight number, train number, bus number, boat number, name of transportation service provider and name of the transport service provider representative allocated to meet the traveler.

Typically, the computer enabled software is linked to a first database of a first transport service provider, preferably the computer enabled software is linked to several different databases of several different transport service providers. In an example embodiment of the invention where the transport services provider may be a taxi service, the computer enabled software is linked to several different databases of several different taxi service operators such that in use, the first, second or subsequent traveler who have booked a taxi service with any one of the several different taxi service operators arrives at the plurality of uprights, identifies his/her name on a display means and is met by a representative of the taxi service.

The computer enabled software is generally also linked to a second database of the transportation hub in use to track arrival times and cause the same to be displayed on at least one of the display 10 means.

In a preferred embodiment of the invention, the computer enabled software is linked to the first database of the first transportation service provider, preferably the computer enabled software is linked to several different databases of several different transport service providers, and the computer enabled software is linked to the second database of the transportation hub, such that in use, the computer can cause the names of first, second and subsequent travelers to be displayed in order of arrival times. Once the first traveler has been met by the first representative the computer causes the display means to display a second traveler. It is to be understood that after the first traveler has been met by the first representative a signal is sent to the computer to display the name of a second traveler. Said signal may be manually input into the computer and/or may be sent to the computer via an email or SMS or other electronic communication means.

The computer may be linked to the plurality of display means via a wireless connection. The computer may also be linked using conventional cabling technologies. A combination of wireless and conventional cabling technologies is also envisaged.

It is envisioned that the method may include a further step 124 whereby the first, second and subsequent traveler may receive an electronic communication from the computer upon arrival at the transportation hub informing said traveler where the system is located in the transportation hub and/or at which display means he/she should report to and/or the name of the representative 16 of the transportation service provider. The electronic communication may be, but not limited to, at least one of the following forms: SMS and email, which may be received by the traveler's own computer and/or smart phone and/or tablet. Typically, this step occurs between step 114 and 116.

The Applicant believes the invention may at least alleviate congestion at arrival halls for various transportation means, such as for example airports. Further, the Applicant believes the invention may decrease the time taken for a traveler to meet with his/her transportation service provider, such as for example a taxi driver from a taxi service booked by the traveler.

While the invention has been described in detail with respect to specific embodiments and/or examples thereof, it will be appreciated that those skilled in the art, upon attaining an understanding of the foregoing may readily conceive of alterations to, variations of and equivalents to these embodiments. Accordingly, the scope of the present invention should be assessed as that of the claims and any equivalents thereto, which claims are be appended hereto.

1. A system for providing transportation services to a traveler arriving at a transportation hub, the system comprising a plurality of uprights, each upright having a display means connected thereto, the plurality of uprights arranged in discrete rows, the length of the uprights being selected so as to prevent obstruction of any one of the display means, each display means being connected to a computer which causes at least a first name of a first traveler to be displayed on one of the plurality of display means, such that in use, the first traveler identifies a display means displaying his/her name and positions himself/herself at the display means bearing his/her name to be met by a representative of a transportation service provider.

2. The system of claim 1, wherein the uprights in each different row are of a particular length, such that in use, a front row includes uprights of a lowest length and a back row includes uprights of a greatest length allowing the display means in each of the rows to be un-obscured for visual recognition by the traveler.

3. The system of claim 2, wherein the rows form straight lines, and/or the rows are curved.

4. The system of claim 1, wherein the computer includes computer enabled software containing information about at least first, second and subsequent travelers, and wherein such information includes at least one of the following group: name, surname, identification number, photo identification, scheduled arrival time, mode of arrival, flight number, train number, bus number, boat number, name of transportation service provider and name of the transport service provider representative allocated to meet the traveler, such that in use, any of the aforementioned information is displayed on the display means, alone or in combination.

5. The system of claim 1, wherein each of the plurality of uprights includes two display means.

6. The system of claim 4, wherein the computer enabled software is linked to a first database of a first transport service provider.

7. The system of claim 4, wherein the computer enabled software is linked to a second database of the transportation hub in use to track arrival times and cause the same to be displayed on at least one of the display means.

8. The system of claim 1, wherein each of the plurality of uprights has adjacent thereto a seating arrangement, in use, allowing the representative of the transportation service provider to wait for the arrival of the traveler.

9. The system of claim 1, wherein each of the plurality of uprights may have a seating arrangement integral thereto, in use, allowing the representative of the transportation service provider to wait for the arrival of the traveler.

10. The system of claim 1, wherein the computer is linked to the plurality of display means via a wireless connection and/or via conventional cabling technologies.

11. A method for providing transportation services to a traveler arriving at a transportation hub, the method comprising the following steps:
a first traveler making a reservation for a first transportation service provider;
the first transportation service provider sending information relating to the first traveler to a computer;
the computer causing the name of the first traveler to be displayed on a display means that is mounted to an upright and located at the transportation hub;
the first traveler reporting to the display means bearing his/her name;
a first representative of the transportation service provider meeting the first traveler;
communicating with the computer that the first traveler has been met by the first representative; and
the computer causing the name of a second traveler to be displayed on the display means.

12. The method according to claim 11, wherein the display means and upright form part of a system comprising a plurality of uprights, each upright having a display means connected thereto, the plurality of uprights arranged in discrete rows, the length of the uprights being selected so as to prevent obstruction of any one of the display means.
